(19) United States
(12) Patent Application Publication
(10) Pub. No.: US 2002/0078041 A1
(43) Pub. Date: Jun. 20, 2002

(54) System and method of translating a universal query language to SQL

(76) Inventor: William Chyi Wu, Fremont, CA (US)

Correspondence Address: OPPENHEIMER WOLFF & DONNELLY, P. O. BOX 10356, PALO ALTO, CA, 94303, US

(21) Appl. No.: 09/976,439

(22) Filed: Oct. 12, 2001

Related U.S. Application Data
(60) Provisional application No. 60/240,375, filed on Oct. 13, 2000.

(51) Int. Cl. G06F 7/00

(52) U.S. Cl. 707/4

(57) ABSTRACT

A system and method for translating a universal query language UQL into a relational query language such as SQL. The method first determines whether there are any UQL rule properties. If so, the rule is substituted for the rule property. Next, for each resource and resource property, a relational table is assigned and given an ID. Assigned tables are placed into a table list. Following this step, for each resource property, implied conditions are generated and placed into a condition list and, if needed, additional tables are generated and assigned ids. Then, for each UQL primitive property, a table and column is identified according to a table.column format and placed into a column list. Finally, any predicates are resolved into explicit conditions and the conditions are placed into the condition list. From the column list, the table list and the condition list an SQL statement is formed for querying the relational database.

### CROSS-REFERENCE TO RELATED APPLICATIONS

Reference is made to and priority claimed from U.S. Provisional Application No. 60/240,375, filed Oct. 13, 2000, entitled “A Method of Translating a Universal Query Language to SQL,” and is incorporated by reference herein. This application is further related to U.S. Application No. 60/240,376, filed Oct. 13, 2000, entitled “Apparatus and Method for Operating an Information Deposit and Retrieval System with Resource Property System.”

### FIELD OF THE INVENTION

The present invention relates generally to a language translator and more specifically, a translator that converts a universal query language query into an SQL query.

### DESCRIPTION OF THE RELATED ART

Currently, databases are the standard method of storing data in a settings where more than just a file system is required. One example is the use of Web servers that can publish hypertext documents with dynamic content. In such a case and in many others, the database and the database server are based on the relational model and employ a language such as the structured query language (SQL) to request information from the database. The relational model organizes the data into a number of tables having one or more rows and columns and the SQL queries perform operations on one or more of the tables in the database to yield the requested results.

However, with the advent of the Web application on the Internet, new techniques for representing structured data have emerged. One of these is Extensible Markup Language (XML), which goes beyond the popular Hypertext Markup Language (HTML) by providing a more comprehensive mechanism (a meta-language) for representing the structure of more complex types of data, such as compound documents, database records, and spreadsheet data. Additionally, languages, such as XML Query Language (XQL), have been developed to query XML documents in a database-like fashion, but XML cannot query a relational database.

Thus, there is a need for a query language that is truly universal, a language that can be used to query relational databases, XML documents, directories and folders.

### BRIEF SUMMARY OF THE INVENTION

One object of the present invention is to provide a database query language translator that permits the query of a great variety of data items.

Another object of the present invention is to provide a query that can be represented as strings to be used in URL or embedded in attributes.

In an exemplary embodiment of the present invention, a relational database includes a first entity including an identification field and an identity field of a said first entity; a second entity including an identification field and an identity field of said second entity; and a third entity having a first field for identifying an entry in said first entity, a second field for identifying an entry in said second entity, and a third field for identifying the position of said entity identified in said second field.

In another exemplary embodiment of the present invention, a system for translating a query language including a query translator; a first input coupled to said translator for receiving a universal query language statement; a second input coupled to said translator fore receiving a configuration information; and an output coupled to said translator for generating a structured query language statement.

In yet another embodiment of the present invention, a method of translating a query based on a resource-property model having a rule string into a statement for querying a relational database, having at least one resource in said model; at least one property in each resource; substituting the rule string for a rule property derived from the resource-property query; assigning a relational table having an ID to the resource and entering the assigned table ID into a table list for each resource and resource property derived from the query; determining any link element based on the resource property and entering the link element into a link list for each resource property derived from the query; assigning a table and column to a primitive property and entering the table and column into a column list for each primitive property derived the query; and forming a relational query statement from the column list, the table list and the link list.

One advantage of the present invention is that it incorporates a model that permits the query of a great variety of data items, including relational databases.

Another advantage of the present invention is that queries can be represented as strings that can be used in URLs or embedded in attributes.

### BRIEF DESCRIPTION OF THE DRAWINGS

These and other features, aspects and advantages of the present invention will become better understood with regard to the following description, appended claims, and accompanying drawings where:

FIG. 1 is a block diagram illustrating a representative computer network in which the present invention operates;

FIG. 2 shows an alternative computer network in which the present invention operates;

FIG. 3 shows a representative computer system shown in FIGS. 1 and 2;

FIG. 4 shows the UQL to SQL translator with its inputs and outputs;

FIG. 5 shows a representative resource model for a pair of entities;

FIG. 6 shows a representative relational model for a pair of entities;

FIGS. 7A and 7B show a flow chart illustrating the steps for constructing a resource model from an existing relational model;

FIG. 8 shows a flow chart illustrating the steps for constructing a relational model from an existing resource model;

FIG. 9 shows the production forms for the Universal Query Language (UQL);

FIG. 10 shows a specification describing the resource model of FIG. 5, the relational model of FIG. 6, and a mapping between them;

FIG. 11 shows a flow chart illustrating the overall process for converting a UQL query into a relational query; and

FIGS. 12A to 12L show a set of flow charts illustrating the steps for converting a UQL query into a relational query.

### DETAILED DESCRIPTION OF THE INVENTION

The present invention provides apparatuses and methods for designing a resource property system in a computer system and/or over a computer network. In the following description, in order to illustrate the present invention, references are made to computer systems and networks. It will be obvious, however, to one of ordinary skill in the art that these systems are provided to illustrate the application of the present invention and are not required to practice the present invention. In other instance, generally understood components of computer systems and networks are not described in detail so as not to unnecessarily obscure or burden the description of the present invention. The embodiments of the present invention described below are provided in software. However, according to the principles of the present invention illustrated below, hardware embodiments of the present invention are also feasible.

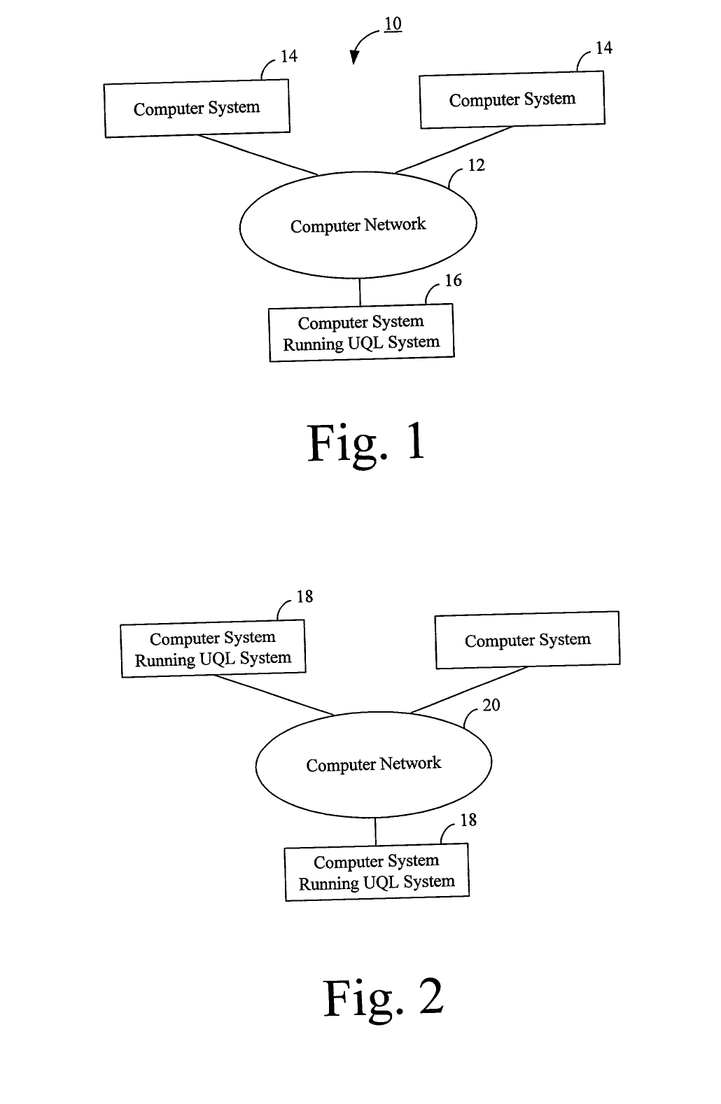

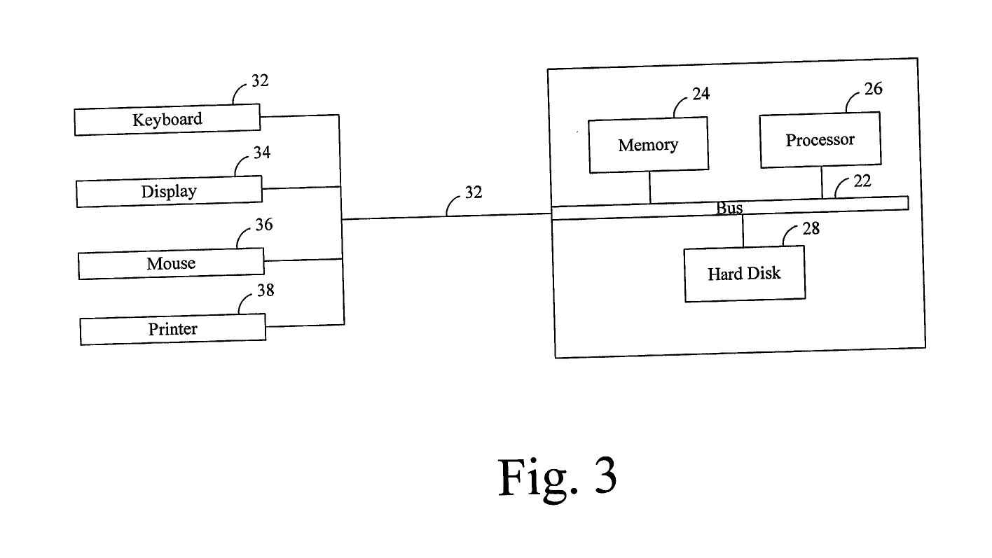

FIG. 1 is a block diagram illustrating a representative computer network system 10 in which the present invention operates. A computer network 12 interconnects a plurality of computer systems 14, 16, one of which, computer system 16, runs the Universal Query Language (UQL) system. Alternatively as shown in FIG. 2, the UQL system resides on many computer systems 18 and is accessible through the computer network 20. FIG. 3 shows a representative computer systems shown in FIGS. 1 and 2, in which a central bus 22 interconnects a memory subsystem 24, a processor 26 and a hard disk storage device 28 and there is an interface between an I/O bus 30 to the central bus 22. The I/O bus 30 hosts a standard set of peripheral devices such as a keyboard 32, display 34, mouse 36 and printer device 38.

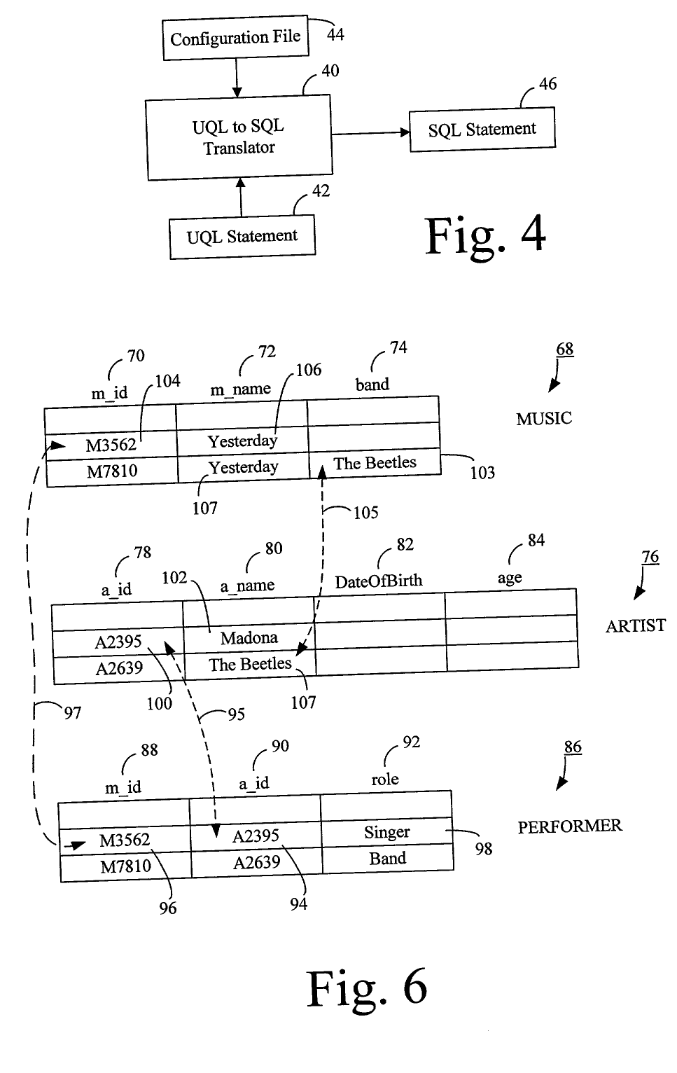

FIG. 4. shows the UQL to SQL translator 40 with its inputs and outputs. It takes as input a UQL statement 42 and processes it. During the processing, it consults a configuration file 44 to obtain the property mapping information between resources in UQL and tables needed in SQL. Then it outputs the translated SQL statement 46.

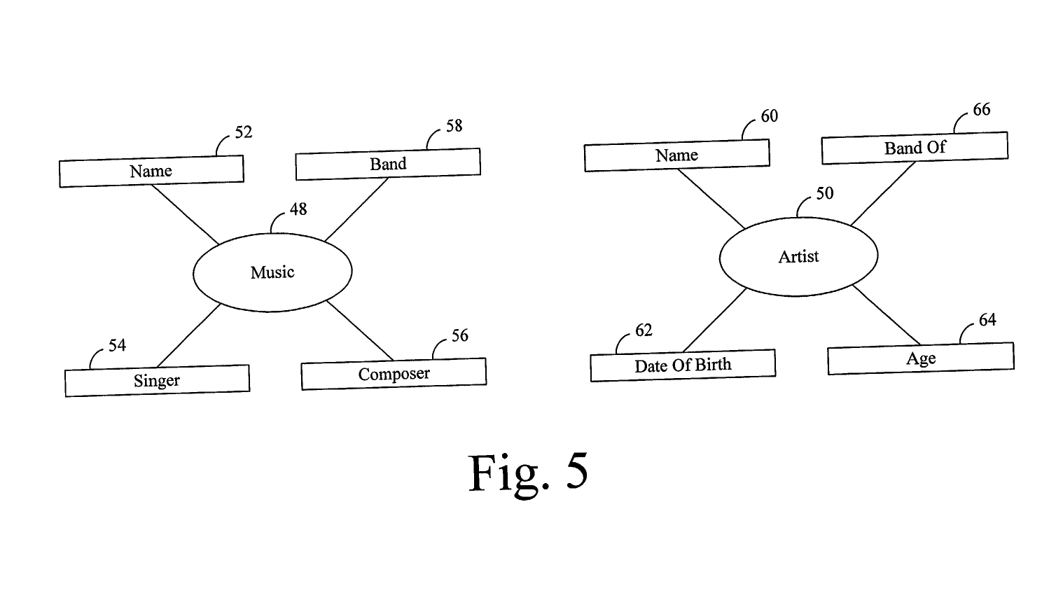

FIG. 5 shows a representative resource model for a pair of entities, the Music resource 48 and the Artist resource 50. The Music resource 48 has the properties name 52, singer 54, composer 56, and band 58. The Artist resource 50 has the properties name 60, dateOfBirth 62, age 64 and bandOf 66. In the Property/Resource model, every data object, such as Music and Artist, is modeled as a Resource. Thus, Web pages, pictures, spreadsheets are resources and each resource has a potentially unlimited number of properties, which are name/value pairs, where the name is a string of characters and the value can be either a primitive value, a resource, a function, or a collection of values. Because the value of a resource property can be another resource, the model is hierarchical. The Property/Resource model is more thoroughly described in a related U.S. Application No. 60/240,376, entitled “APPARATUS AND METHOD FOR OPERATING AN INFORMATION DEPOSIT AND RETRIEVAL SYSTEM WITH RESOURCE PROPERTY SYSTEM ”, filed on Oct. 13, 2000, and incorporated by reference herein.

A resource property system contains a number of resources. Each resource has one or more of properties. Each property consists of a name and a value. The name is a string of characters. Different properties of the same resource must have different names. The value of a property can be either a primitive value, a resource, a function, or a collection of values. A primitive value is one that is not a resource, a function or a collection. Examples of primitive values are integer, number, binary values, pictures, etc. A function is something that can accept arguments and return results through invocation. There are two types of collections, bag and sequence. A bag is simply a collection of values that have not order. A sequence is an ordered collection of values.

Although not essential, a reserved property name is an “ID”, which is used to quickly identify a resource. The content of an “ID” is preferable to be unique within a single resource property system. A system that ensures the values of all “ID's” of its resources is a unique ID system. A unique ID system does not guarantee that all resources have an “ID”, but they are unique if they exist in the system.

In the present invention, both the resource model described in conjunction with FIG. 5 and the relational model described in accordance with FIG. 6 are exemplary embodiment to be incorporated into the configuration file 44 illustrated in FIG. 4.

FIG. 6 shows a representative relational model for a pair of entities. In the relational model, entities are represented as tables. A record or row of the table comprises a number of fields or columns. In the music table 68, there are columns m_id 70, m_name 72 and band 74. In the artist table 76, there are columns a_id 78, a_name 80, dateOfBirth 82 and age 84. In the performer table 86 there are columns m_id 88, a_id 90 and role 92. The a_id 90 field in the performer table 86 is the foreign key for the artist table 76 and the m_id in the performer table 86 is the foreign key for the music table 68. The value of the role field 92 is either “singer” or “composer”. The performer table 86 defines a relation between artist and music. For example, suppose there is an entry in the performer table 86 with a_id=‘A2395’ 94, m_id=‘M3562’ 96 and role=‘singer’ 98, as shown in FIG. 6. If, in the artist table 76, the a_name 80 entry with a_id=‘A2395’ 100 is Madonna 102 and, in the music table 68, the m_name 72 entry with m_id=‘M3562’ 104 is ‘Yesterday’ 106, it means that Madonna has the role as singer for the music entitled ‘Yesterday’. In the above example, the role is identified as a singer as this example is for the performance of a music. The role could be a character if the model relates to a movie, or could be a position if the model relates to an organization, or a location if the model relates to a geographical expression.

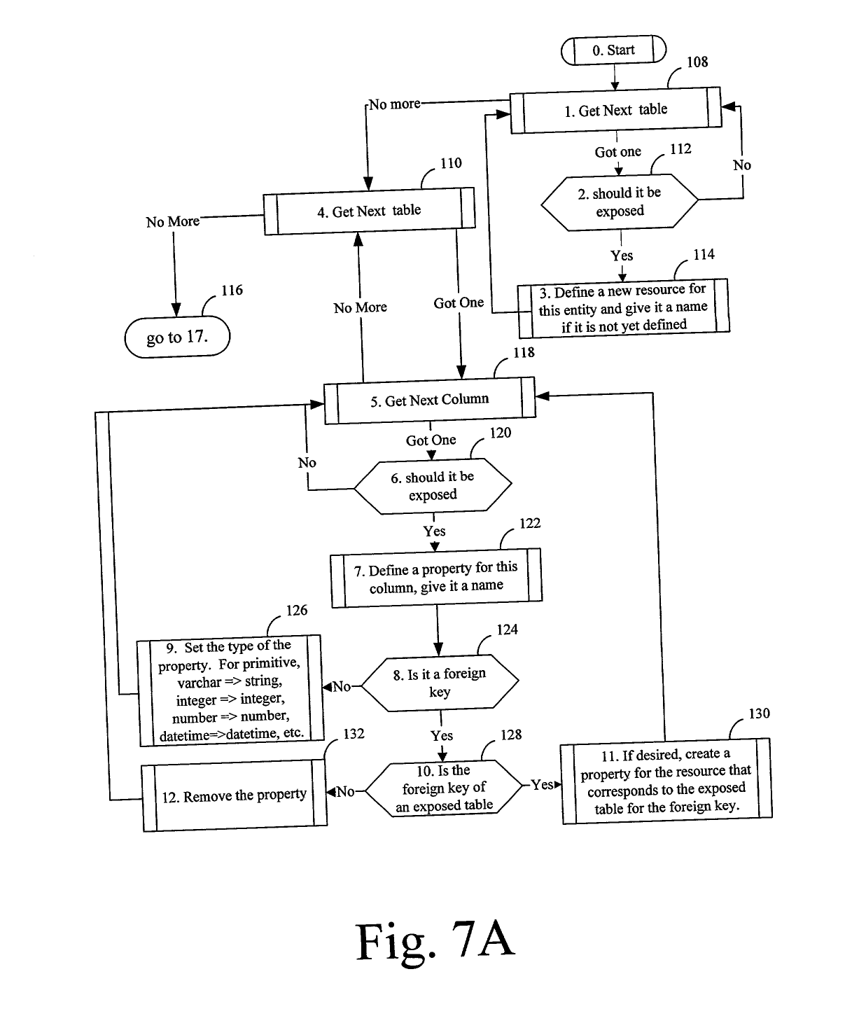

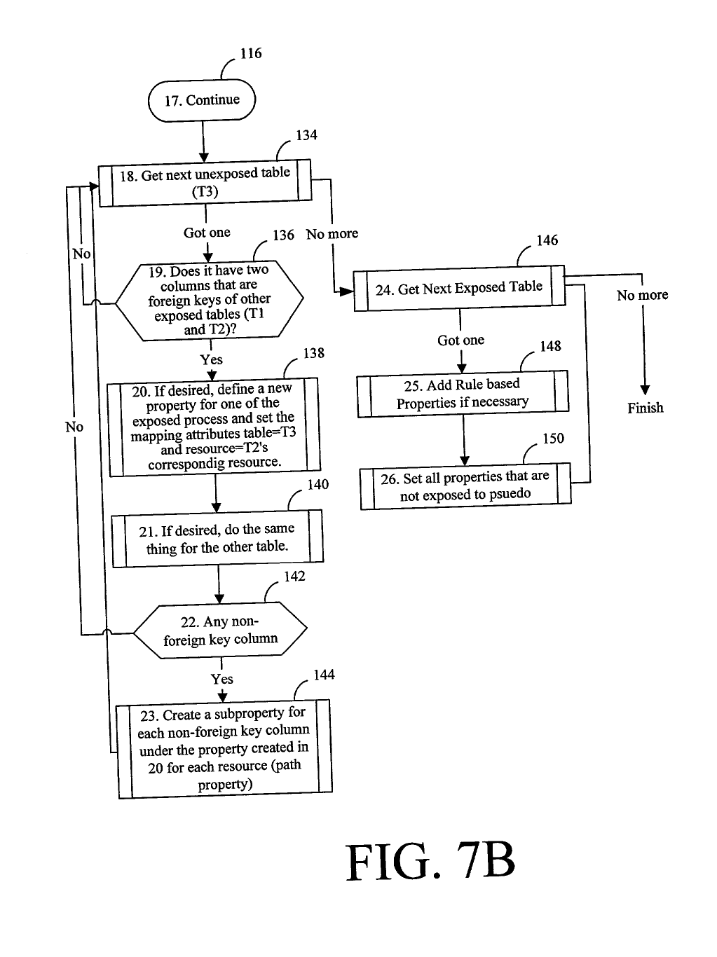

FIGS. 7A and 7B show a flow chart illustrating the steps for constructing a resource model from an existing relational model. This approach exports data from an existing database to define resources based on the database.

Step 1 (108). For each table, get one at a time. If there are no more tables go to Step 4 (step 110). In the above example, the first iteration obtains the music table, the second iteration obtains the artist table and the third iteration obtains the performer table.

Step 2 (112). It determines whether or not this table is to be exposed. If the process determines that the table is not to be exposed, go back to Step 1 (108). In this example, the performer table is not exposed. Any table that is exposed should have a primary key. Because the performer table in the example does not have a primary key it cannot be exposed as a resource.

Step 3 (114). Define a new resource for this table and give it a name if not yet defined. For example, the Music resource is defined for music table and Artist resource is defined for artist table. After defining the name, the process goes back to Step 1 (108).

Step 4 (110). For each exposed table, get one at a time. If there are no more exposed tables, go to Step 17 (116) to continue the process. If there are, then call the exposed table T and its corresponding resource R. For example, if T is the music table, the corresponding resource R is the Music resource.

Step 5 (118). For each column in the table, get one at a time. If there are no more columns, go back to Step 4 (110). If there are more columns, call the column C. In the music table 68 (FIG. 6), m_id 70 and m_name 72 are columns C in the music table 68.

Step 6 (120). Next step is to check whether or not the column obtained should be exposed? If the column should not be exposed, go back to Step 5 (118). For example, m_id is not exposed to be exposed. The process continue to step 7 (122) if the column is to be exposed.

Step 7 (122). Defines the property name P for this column. In the example, m_name is exposed and a property name in the Music resource is created for it. Steps 8 (124). Determines whether or not a column is a foreign key. If the column C is not a foreign key, then the process proceeds to Step 9 (126).

Step 9 (126). If the column C is not a foreign key, then sets the type of the property to be a primitive property of which there are four types, string, integer, number and datetime. For example, the property name in Music resource is type string and go back to Step 5 (118).

Step 10 (128). Determines whether or not the column C contains a foreign key for another exposed table T2. If desired, then go to Step 11 (130).

Step 11 (130). If column C contains a foreign key for another exposed table T2, then defines a property for the resource that corresponds to table T2. For example, the column, “band” 72 of the music table 68 is a foreign key for the artist table 76. It is possible to define a resource property bandOf for the Artist resource with the value of the Music resource. After this Step 11 (130), the process goes back to Step 5 (118).

Step 12 (132). If column C is determined to be a foreign key for an unexposed table in Step 10 (128), then the column should not be exposed and the property will be removed (132). After this Step 12 (132), the process goes back to Step 5 (118).

Step 17 (116) is continued from Step 4 (110) if there is no more exposed table.

Step 18 (134). For each unexposed table, get the next one. If no more, go to Step 24 (146).

Step 19 (136). Determines whether or not the unexposed table T3 has multiple columns that are foreign keys of other exposed tables (T1 and T2).

Step 20 (138). If the unexposed table T3 has two columns C1, C2 that are foreign keys for the two exposed tables T1 and T2, it is possible to define a property P1 for T1's corresponding resource R1, whose value is the corresponding resource R2 of T2. In the configuration mapping for P1, there will be a resource attribute with value R2 and a table attribute with value T3.

Step 21 (140). A similar process can be done with T2. For example, in the performer table 86 (FIG. 6), there are two columns, m_id 88 and a_id 90, that are the foreign keys for the music table 68 and the artist table 76, respectively. Therefore, it is possible to create an artist property (P1) for Music resource (R1), with resource attribute in the mapping to be Artist (R2) and table attribute to be performer (T3). Step 22 (142). Determines whether or not any non-foreign key column is present in table T3.

Step 23 (144). If table T3 has additional non-foreign key columns, they can be defined as path properties of the resource R1 and R2. For example, the role column 92 (FIG. 6) in the performer table 86 can be defined as the path property under the artist property of the Music resource. After completing this Step 23 (144), the process goes back to Step 18 (134).

Step 24 (146). For each exposed table, get one table a time. If no more left, the process is complete.

Step 25 (148). After getting the next exposed table, add rule properties to this table if necessary. The process continues to Step 26 (150).

Step 26 (150). If the rule property depends on some undefined properties, defines them in the mapping section as pseudo-properties. After completing this operation, the process goes back to Step 24 (146) to get the next exposed table.

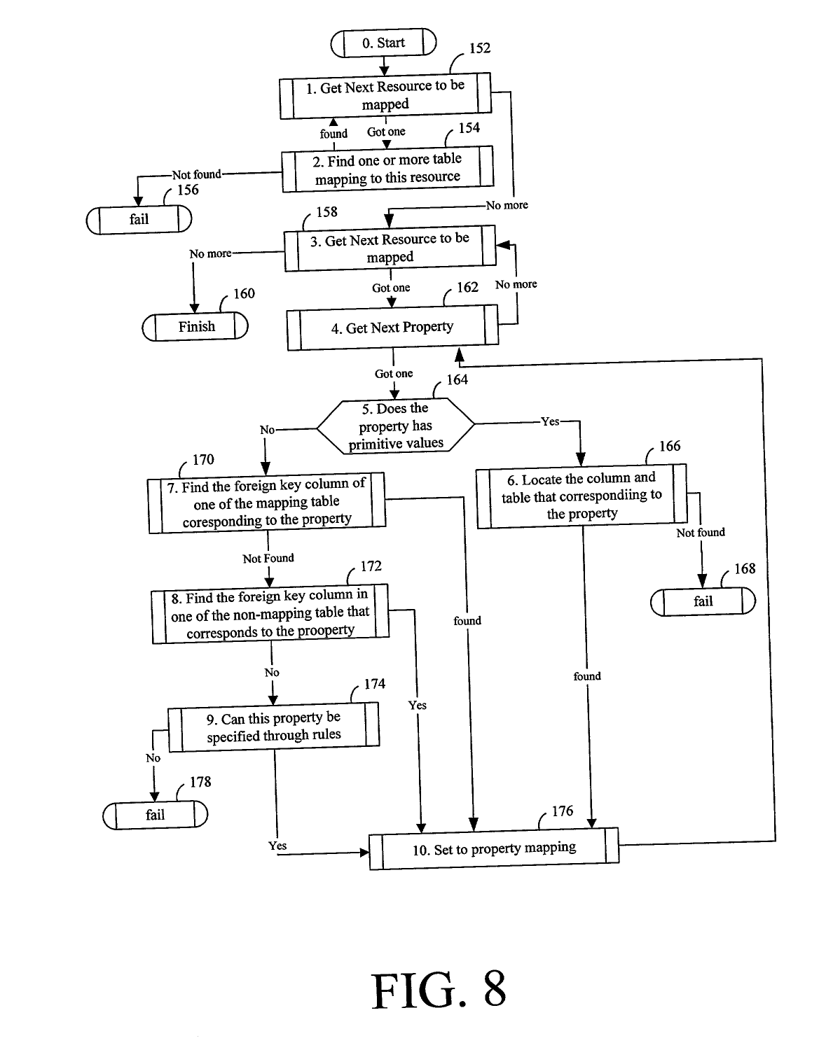

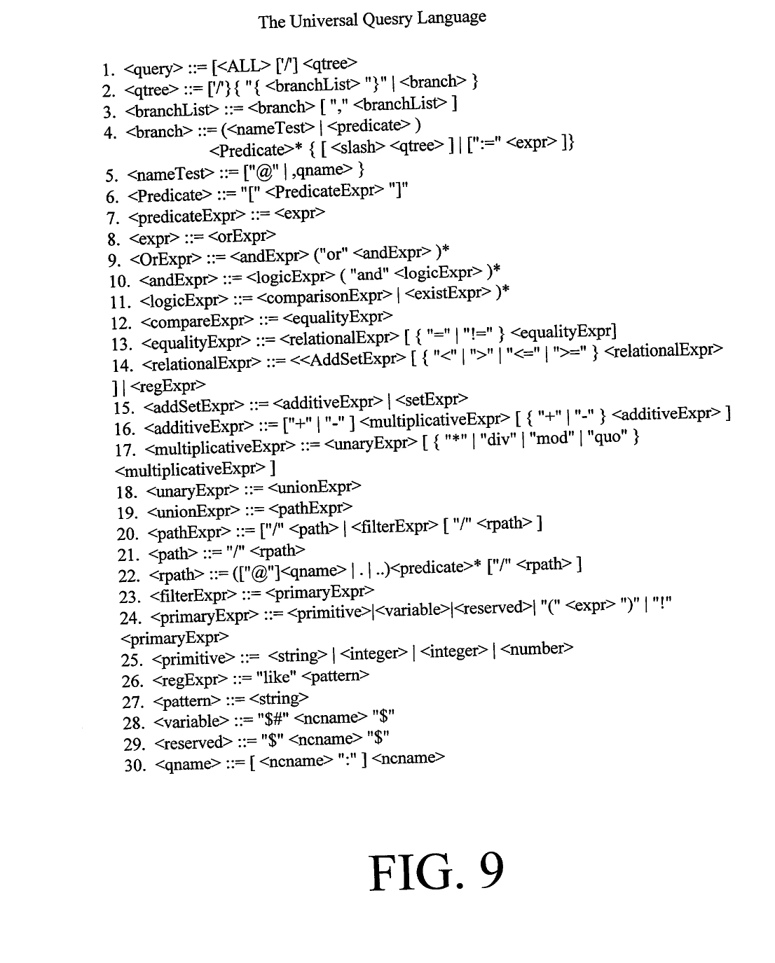

FIG. 8 shows a flow chart illustrating the steps for constructing a relational model from an existing resource model.

Step 1 (152). For each resource, get one at a time.

Step 2 (154). In general, there must be one or more tables that correspond to the resource itself and this step finds such a corresponding table or tables. If there are no such tables, the process fails (156). In the example, Music resource has corresponding music table while Artist resource has corresponding artist table.

Step 3 (158). For each resource, get one at a time until no more remain, at which point the process is finished (160).

Step 4 (162). For each property, get one at a time until no more remain. Then go back to Step 3 (158).

Step 5 (164). Determines whether or not the property has primitive values. If the property does not have primitive values, go to Step 7 (170).

Step 6 (166). If the property does have primitive values, then finds the table and the column that should map to this property. If the process finds the column and table corresponding to the property, then it continues to Step 10 (176). For example, Music resource's m_name property has primitive value. Otherwise, the process fails (168). Step 7 (170). If the process has primitive values, then the next step is to find the foreign key column of a table in the one of the mapping tables that corresponds to the property. If found, go to Step 10 (176), otherwise continues to Step 8 (172). For example, the band property of the Music resource can be mapped to the band column 74 (FIG. 6) of the music table 68, which is a foreign key for the artist table 76.

Step 8 (172). If the process cannot find a foreign key column of a table in the one of the mapping tables that corresponds to the property, then it proceeds to find the reverse corresponding column in tables not one of the corresponding tables. If not found, go to Step 9 (174). Otherwise, continues to Step 10 (176). For example, bandOf property of the Artist resource has the band column 74 in music table 68, which has the reverse meaning. So the mapping has attribute table to be music and resource to be Music.

Step 9 (174). If the process cannot find the reverse corresponding column in tables not one of the corresponding tables, it then proceeds to determine whether or not this property can be specified through rules. If the property can be specified by a rule, then it proceeds to Step 10 (176). Otherwise, the mapping fails (178). For example, the singer property of the Music resource can be specified through a rule.

Step 10 (176). This step sets the property mapping.

FIG. 9 shows the production forms for the Universal Query Language (UQL). The syntax of these queries is described briefly below. In line 1, a query comprises an optional keyword “ALL” which is followed by a “/” and a query tree “qtree”. In line 2, a query tree includes a branch list “branchlist”, which has one or more branches. In line 4, a branch is either a nameTest or a predicate. In line 5, a name test is a query name “qname”. In line 6, a predicate is one of many types of expressions. One type of expression is a path expression.

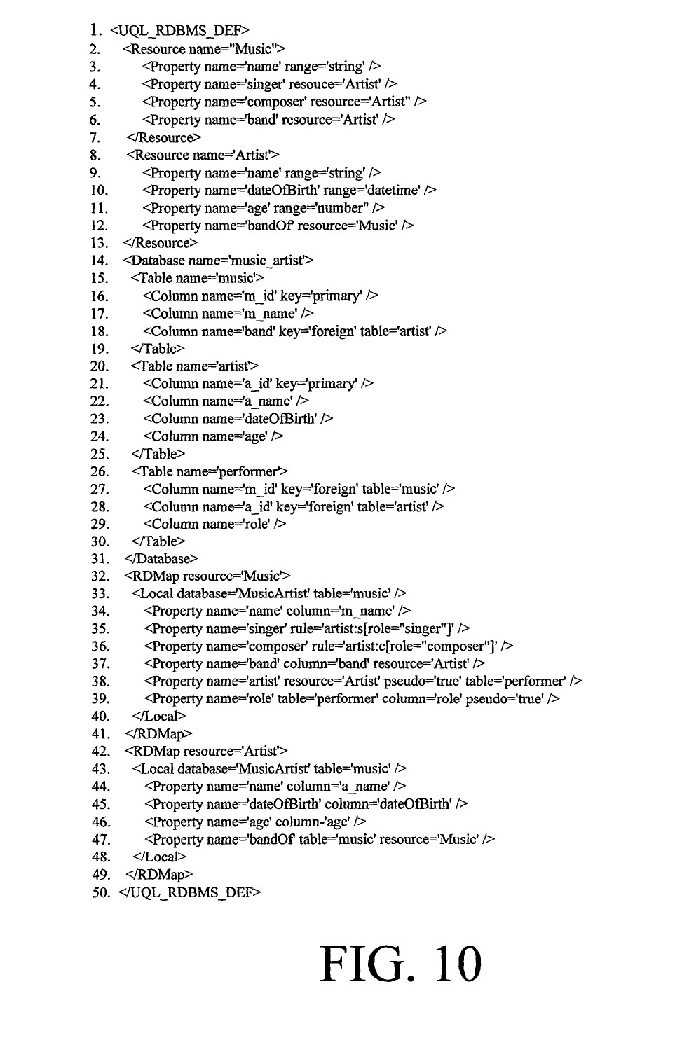

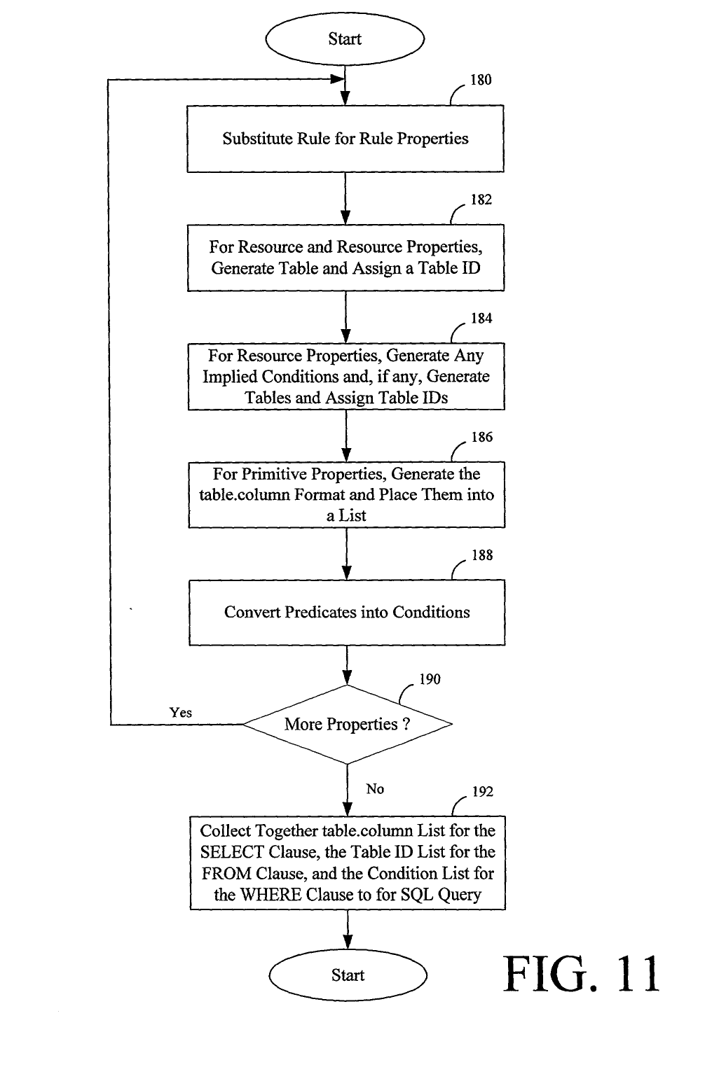

FIG. 10 shows an XML specification (although any format could be used) describing the resource schema of FIG. 5, and the relational schema of FIG. 6. The tag <UQL_RDBMS_DEF> (line 1) marks the entire definition. The <Resource> (lines 2-13), <Database> (lines 14-31), and <RDMap> (lines 32-50) mark the resource, database and the map sections, respectively. <Table> (lines 15-50) is the database table, <Property> (lines 3-6, 9-12, 34-39, and 44-47) defines a property of the resource. <Local> (lines 33, 40 and 43, 48) indicates it is a local database. If there is a remote database, information specifying how to connect to the database is needed. The mapping is rather straightforward. It is always from the resource to the database tables.

In the configuration file, first the resources are described. The text between the tags <Resource name=‘Music’> (line 3) and </Resource> (line 7) specifies the Music resource. The text between the tags <Resource name=‘Artist’> (line 8) and </Resource> (line 13) defines the Artist resource. Next, the relational database tables, music, artist, and performer are described and are contained in the music_artist database (line 14). The above definitions of the resources and the relational database tables are consistent with the diagrams shown in FIG. 6.

In addition, a mapping between the resource schema and the relational schema is specified between the tags <RDMap resource=‘Music’> (line 32) and </RDMap> (line 41) and <RDMap resource=‘Artist’> (line 42) and </RDMap> (line 49). The Artist resource maps in a straightforward manner to the artist table, but the mapping of the Music resource illustrates several different types of mappings, which are discussed and illustrated below.

A resource can be mapped into one or more table. The mapping depends on the meaning of each property of the resource and the meaning of each column of tables. They must match semantically. A primitive property that has primitive data such as string, integer, date, etc., is mapped into a column of a table. In the Music resource, the property, name, is mapped into the column, m_name 72 (FIG. 6), of the music table 68.

A resource property is a property whose value is another resource. It can be mapped in several ways depending on the semantics. It may be mapped into a column, which stores the foreign key for another table. For example, the property, band (line 6), is mapped into the column, band, in the music table (line 6). Another possible case is that a resource property is mapped into a resource and its corresponding table. For example, the property, bandOf (line 12), in the Artist resource (line 8) is mapped into the resource, Music, and its corresponding table, music. This is done because the property bandOf of the Artist resource is derived from the band property of the Music resource. There is no column in the tables that directly corresponds to this property.

Some properties, called rule properties, do not have directly corresponding columns, rather, they are generated by rules. For example, the property, singer (line 35), is generated by the rule artist:s[role=“singer”] (line 35), which means the property is replaced by the rule during the processing. The rule causes the system to find the property, artist, of the Music resource where the artist's role is singer of the music. The “:s” after the artist is to distinguish singer from composer after rule replacement. However both artist:c (line 36) and artist:s (line 35) mean the artist property. During the rule mapping, a rule may refer to a non-existent property, called pseudo-property. A pseudo-property only exists in the mapping. In the case of singer, the rule refers to a property called artist. However, the Music resource does not have the artist property, so it is artificially created. Once created, it must be mapped. The mapping is the same as other resource properties. In the case of the pseudo-property, artist, the property is mapped to the resource, Artist, and a table, performer.

Some properties, called path properties, are nested within other properties. For example, the property ‘role’ (line 39) in the Music resource (line 32) mapping is a path property. The mapping of a path property follows the methods described above.

In the present invention, mapping and modeling rules from entity-relation model to resource-property model can be accomplished through one of the following approach.

1. For each entity table, create a resource. For instance, as shown in FIG. 10,

| Table | Resource |
|---|---|
| music [68 (FIG. 6), line 15 (FIG. 10)] | Music [50 (FIG. 5), line 2 |
| | (FIG. 10)] |
| artist [76 (FIG. 6), line 20 (FIG. 10)] | Artist [48 (FIG. 5), line 8 |
| | (FIG. 10)] |

2. For each relation table, a resource can either be created or omitted. A relation table has more than one foreign key or linking key. It usually establish an N×N relationship between two or more tables. For example, as shown in FIG. 10, the performer table 86 (FIG. 6) does not have to have a corresponding Performer resource. In the example shown in FIG. 6, Artist and Music resources are defined but does not include a Performer resource. Further, in the example in FIG. 10, Resources include Music and Artist, but not Performer (lines 2-13). However, a Performer resource can be created, and it will follow the mapping rules as illustrated in Music and Artist resources.

In the present invention, mapping can be accomplished through one of the following rules:

1. If the property of the resource corresponds to a non-foreign key column of the table, just establish a direct mapping. For instance, in FIGS. 6 and 10, Music resource's (line 2) property “name” has a corresponding column “m_name” as describe in line 34. It is described as

<Property name=‘name’ column=‘m_name’/> in line 34.

2. If the property of the resource corresponds to a foreign key column of the table, the value of the property must be the resource that corresponds to that column. For example, in FIGS. 6 and 10, Music resource's 48 (FIG. 6 and line 2 of FIG. 10) property “band” 58 (line 6 of FIG. 10) corresponds to the music table's 68 (FIG. 6) “band” 74 column, which contains a foreign key “The Beetles” 103 to the artist table 76 as illustrated by dash line 105. The property “band” is mapped to the “Artist” resource. It is described as

<Property name=‘band’ column=‘band’ resource=‘Artist’/>

in line 37 of FIG. 10. The column=‘band’ means it maps to the “band” column. The resource=‘Artist’ means that the value of the property will be the “Artist” resource. In FIG. 6, the band that performed the music “Yesterday” 107 is the artist by the name of “The Beetles” 103 and 107.

3. When a table A has a foreign key to another table B, the resource corresponds to table B can have a property whose content is a resource corresponding to table A. This is the reverse situation of case 2 above. For example, the “Artist” resource 50 (FIG. 5) can have a property called “bandOf” 66. There is no corresponding bandOf column in the “artist” table 76 (FIG. 6). It is created because the “music” table 68 (FIG. 6) has a “band” column 74 which contains a foreign key to the “artist” table 76. In this example, the foreign or linking key is the band “The Beetles” 103 in the Music table 68. It is described as

<Property name=“bandOf” table=“music” resource=“Music”/>

in line 48 of FIG. 10. In this example, the table=“music” means that the property is created because the “music” table 68 has the foreign key and the resource is “Music”.

In FIG. 6, if the band that performed the music by the name of Yesterday 109 is “The Beetles” 103 as shown in the music table 68, the content of “bandOf” 66 of the artist by the name of “The Beetles” is a collection of all music “The Beetles” played. One music item in the collection will have “Yesterday” as its music name.

4. When a table such as the performer table 86 that has two or more foreign keys, it is possible to eliminate the table without creating a corresponding resource. In this example, m_id 88 of the performer table 86 is a foreign or linking key to the music table 68, and a_id 90 of the performer table 86 is a foreign or linking key to the artist table 76. In this case, a property is created in all the resources that correspond to the table pointed by the foreign keys. As is illustrated in FIG. 10, the performer table contains two foreign keys. One for the music table, another for the artist table. The Music resource will have a property called “artist” and the “Artist” resource will have a property called “music”. It is described as

<Property name=‘artist’ resource=‘Artist’ table=‘performer’ pseudo=
‘true’/>

in line 38. In this example, the pseudo=‘true’ indicates that the property “Artist” is not used in the resource itself and only used in the process mapping. If it is false or omitted, it means that the property exists in the resource. Further in this example, the resource=‘Artist’ means that the content of the property is in a resource called “Artist” 50 (FIG. 5). The table=‘performer’ means that it is derived from the performer table 86 (FIG. 6).

In the example shown in FIG. 6, the artist who performed the music M3562's 104 is Madonna 106. M3562 104 in the music table 68 matches with M3562 96 of the performer table 86 as shown by reference line 97. In the same performer table 86, the corresponding artist in the artist table 76 a_id 78 has the content of A2395 100 that links to the artist who performed the music, and reveals that the artist name a_name 80 is identified as Madonna. This is shown by a reference line 95.

5. The performer table 86 has a “role” column 92. The role column 92 can be mapped into a “role” property of the “Music” resource 48 (FIG. 5) and a “role” property in “Artist” resource 50. Although in this example the “roleOf” property of the artist is not shown in either of the resources. In the present invention, t is unnecessary to create a mapping that directly links to a particular column. Such mapping can be derived from indirect linkage. It is described as

<Property name=‘role’ table=‘performer’ column=‘role’/>

in line 39. As indicated above, the pseudo attribute can be omitted if it is false.

In FIG. 6, the role of “Madonna” in the music of “Yesterday” is a “Singer”. The relationship is derived as follows.

(1) Yesterday 106 has a music ID m_id 70 of M3562 104;

(2) the corresponding role 92 in the performer table 86 is a Singer 98;

(3) the corresponding artist ID a_id 90 in the peformer table 86 is A2395 94; and

(4) the corresponding artist name a_name 80 in the artist table 76 of A2395 94 is identified as Madonna.

6. The rule property. Rule property is a property of a resource whose content is derived from a UQL statement. For example in FIG. 10,

<Property name=‘singer’ rule=‘artist:s[role=‘singer’]/>

line 35. What this means is that the “singer” 54 (FIG. 5) property of the Music resource 48 is equivalent to the rule “artist:s[role=‘singer’]”. According to the present invention, this is a way to add more property into a resource whose value is derived from other properties.

FIG. 11 shows a flow chart illustrating the overall process for converting a UQL query into a relational query. A UQL query has a particular form according to the BNF specification of FIG. 9. An example of an UQL select is

uql.select:/music[singer/name=‘Madonna’]/{name,composer/name}.

This query obtains the names, and the composer names of all the music sung by Madonna. A UQL select can be naturally combined with an URL to form a seamless string. For example,

http://www.cytaq.com/uql.select:/music[singer/name=‘Madonna’]/{name,composer/name}

sends the query to the web site of www.cytaq.com. A UQL delete is expressed as

uql.delete:/music[name=‘The way we were’].

It will delete the music with the name ‘The way we were’. A UQL update is expressed as

uql.update:/music[name=‘The way we were’]/{album=‘Best of
Madonna’,singer/name=‘Madonna’}.

It will update the singer's name to Madonna and the album to ‘Best of Madonna’. A UQL insert is expressed as

uql.insert:/music/{name=‘New world symphony’, composer/name=
‘Dvorak’}.

It will insert an entry in the music with the name ‘New world symphony’ and composer with the name ‘Dvorak’. When a UQL request is applied to different systems such as RDBMS or directory system, it is limited by the capability of the underline system itself. For example, if a file is read-only, the delete will fail.

The goal of the translation process is to build three lists which are needed in the output SQL query. The three lists are a list of columns or fields to be output, a list of tables involved in the query and a list of conditions that qualify the query. For example if the query, select:/music[singer/name=‘Madonna’]/{name, composer/name} is issued, the expected output is:

SELECT music1.mname, artist1.aname, artist2.aname

FROM music music1, artist artist1, artist artist2, artist artist3, performer performer1, performer3

| | | |
|---|---|---|
| WHERE | artist3.a_name = | ‘Madonna’ and |
| | artist3.a_id = | performer3.a_id and |
| | musicl.m_id = | performer3.m_id and |
| | performer3.role = | ‘singer’ and |
| | artistl.a_id = | performer1.a_id and |
| | performer1.m_id = | music1.m_id and |
| | performer1.role = | ‘composer’ and |
| | artist2.a_id = | music1.band |

As mentioned above FIG. 11 shows a flow chart illustrating the overall process for converting a UQL query into a relational query.

Operation 1 (180). Replace of Rule Properties by their Rules. Rule properties such as singer are composer are replaced as shown below.

| | |
|---|---|
| property | substituted rule |
| singer | artist:s[role=‘singer’] |
| composer | artist:c[role=‘composer’] |

Operation 2 (182). For resources and resource properties, generate tables and assign an id to each table. For example, Music, artist:c, artist:s, and band are translated as shown.

| Resource | property | tables | conditions |
|---|---|---|---|
| Music | | music1 | |
| | artist:c | artist1 | |
| | band | artist2 | |
| | artist:s | artist3 | |

Operation 3 (184). For resource properties, generate the conditions along the way and, if needed, generate tables and assign them id's. For example, the properties, band, artist:c, and artist:s generate the tables and conditions shown.

| Resource | property | tables | conditions |
|---|---|---|---|
| | band | | artist2.aid = music1.band |
| | artist:c | performer1 | artist1.aid = performer1.aid |
| | | | music1.mid = performer1.mid |
| | artist:s | performer3 | artist3.aid = performer3.aid |
| | | | music1.mid = performer3.mid |

Operation 4 (186). For each primitive property, generate the “table.column” and place the table.column into a list. For example, Music's name property is music1.m_name. The artist:c's name and role property is artist1.a_name and performer1.role. The band's name is artist2.a_name. The artist:s's name and role property is artist3.a_name and performer3.role.

| Resource | property | table.column | conditions |
|---|---|---|---|
| Music | name | music1.mname | |
| | artist:c/name | artist1.aname | |
| | artist:c/role | performer1.role | |
| | band | artist2.aname | |
| | artist:s/name | artist3.aname | |
| | artist:s/role | performer3.role | |

Operation 5 (188). Predicates are those expressions within the brackets. They will be turned into explicit conditions in the WHERE clause of the SQL statement. For example, [artist:s[role=‘singer’]/name=‘Madonna’] will turn into artist3.name=‘Madonna’ and performer3.role=‘singer’. The artist:c[role=‘composer’] will turn into performer1.role=‘composer’.

| predicates | conditions |
|---|---|
| [artist:s[role=‘singer’]/name=‘Madonna’] | artist3.name=‘Madonna’ |
| | performer3.role=‘singer’ |
| [role=‘composer’] | performer1.role= |
| | ‘composer’ |

Operation 6 (190). Determines whether or not more properties need to be processed. The process goes back to Operation 1 (180) to prepare the property if it exists, otherwise it proceeds to Operation 7 (192).

Operation 7 (192). Start with ‘SELECT’, then append table.column list. Append ‘FROM’, then append table and id list. Append ‘WHERE’, then append condition list. The SQL statement is now finally formed.

The above translation shows the significant advantage of UQL to SQL. A resulting SQL select statement from a simple UQL select statement is significantly larger and more complicated.

To facilitate the processing of a UQL query into an SQL query, a path tree data structure is built to determine whether a path has been encountered. For example, the query in the previous example after rule substitution, /Music[artist:s[role=‘singer’]/name=‘Madonna’]/{name, artist:c[role=‘composer’]/name, band/name } has the following path tree, root(Music(artist:s(role, name), name, artist:c(role, name), band(name))). Each element is one node in the path tree. In the example path tree, root, Music, singer, a_name (for artist:s/name), m_name (for Music/name), composer name, band name are nodes.

A node may have many branches, each of which is enclosed in a pair of parentheses. For example, band has a single branch called name. Branches are separated by commas. For example, Music has four branches. Nodes that have no branches are leaf nodes. All the name nodes in the previous example are leaf nodes. The first ‘/’ in the example corresponds to the root node. The path tree is built with the elements encountered along the way. When building the path tree, if a branch has been built already, it will not be added again. Therefore, adding anything into the path tree always implies checking whether it is already there. If it is, nothing is added. For example, the query /Music[name=‘Yesterday’ or name=‘Today’]/{name, artist:c[role=‘composer’]/name, band/name } has the path tree, root(Music(name, artist:c(role, name), band(name))), because there are three instances of the name property of the Music resource, only one is preserved in the tree.

A table list data structure is built during the processing to remember which tables have been encountered. The table list contains (table, table id) pairs. The ID of each table must be unique. When a table is added, it is first checked against existing tables in the list. If it is already in the table list, it is not added.

A column list data structure is built during the processing to remember which columns have been encountered. The column list contains the column and the table to which the column belongs.

A condition list data structure is built during the processing to remember all the conditions which have been encountered. Each condition is a tree structure, which stores the information of an expression. For example, the predicate [name=‘Yesterday’ or name=‘Today’] will generate a condition tree, OR(EQUAL(name,‘Yesterday’), EQUAL(name,‘Today’)) in the condition list. The predicate [role=‘composer’] will generate the tree, EQUAL(role,‘composer’) in the condition list. In the following descriptions, the example /Music[name=‘Yesterday’ or name=‘Today’]/{name, composer/name, band/name } is used to illustrate the translation process.

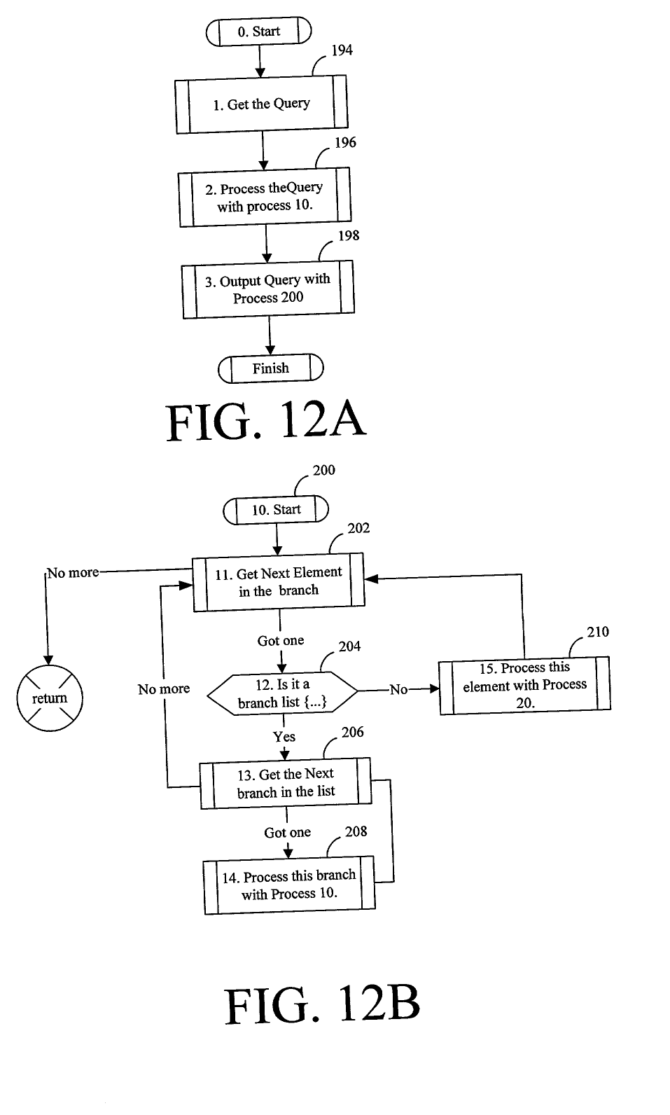

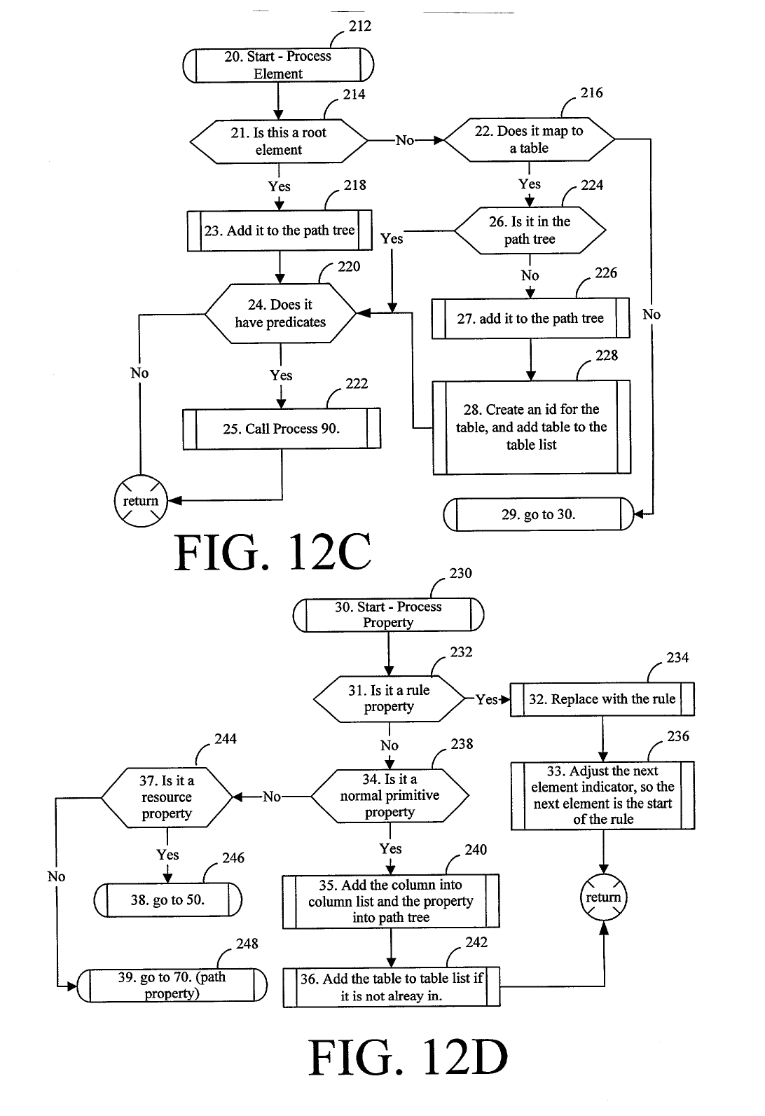

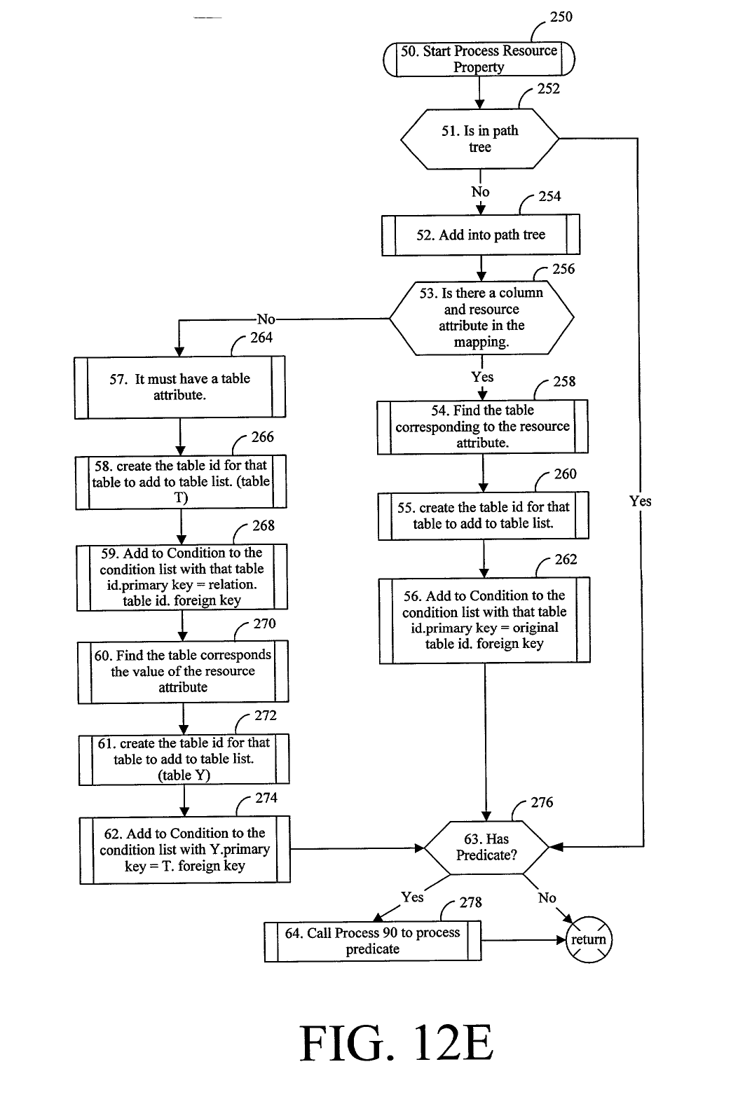

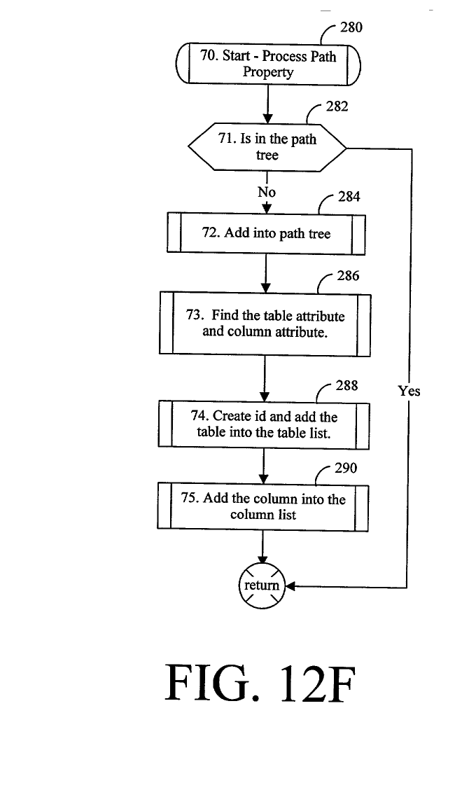

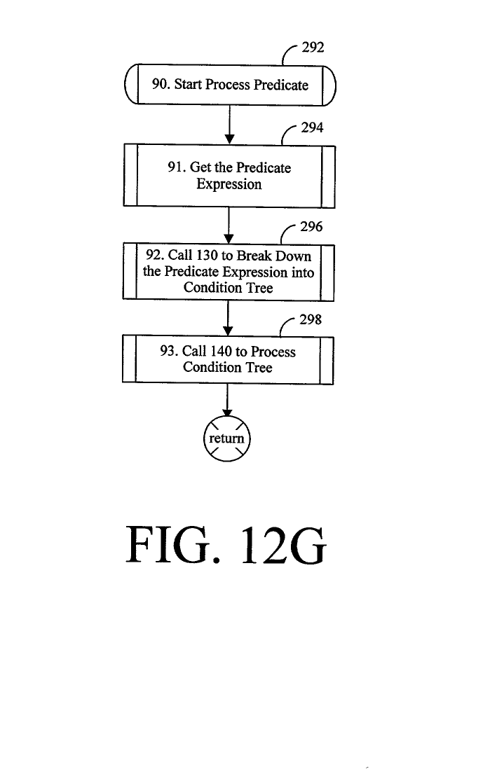

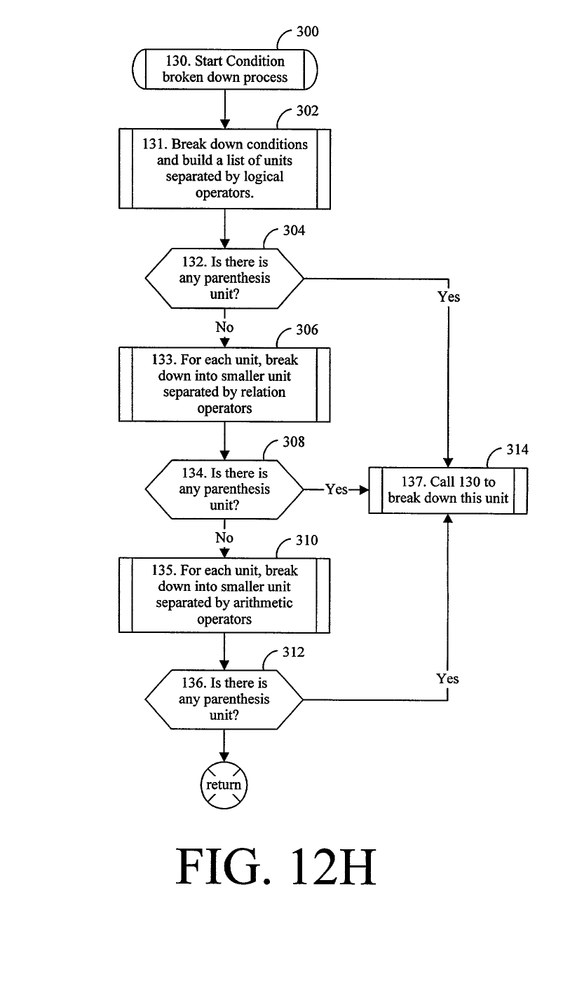

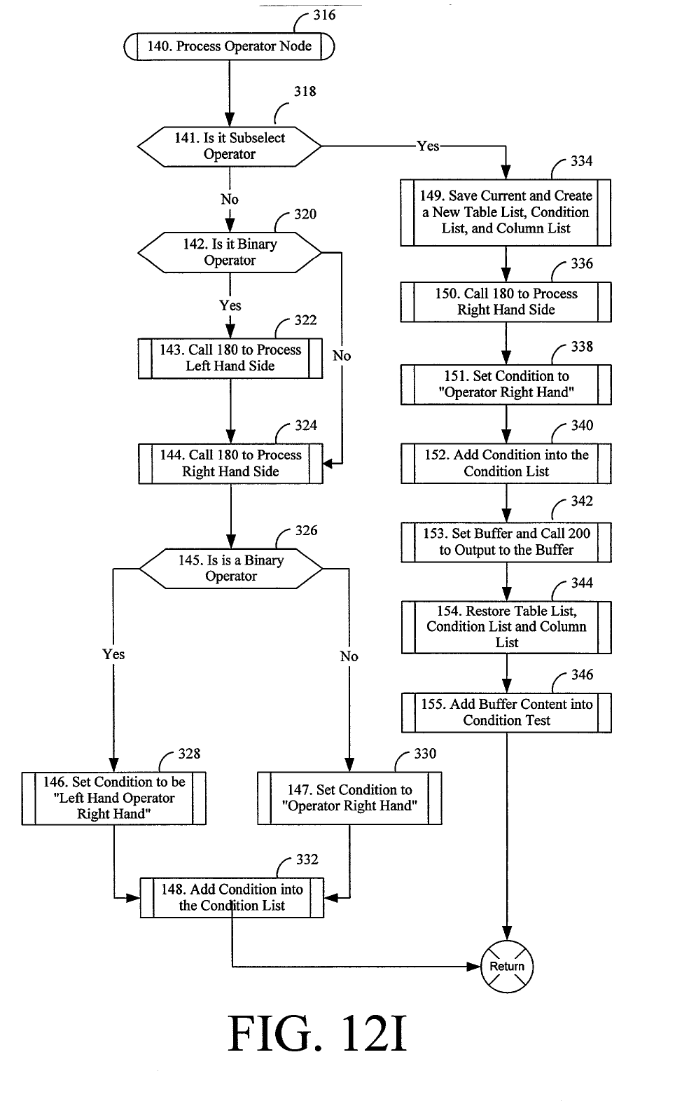

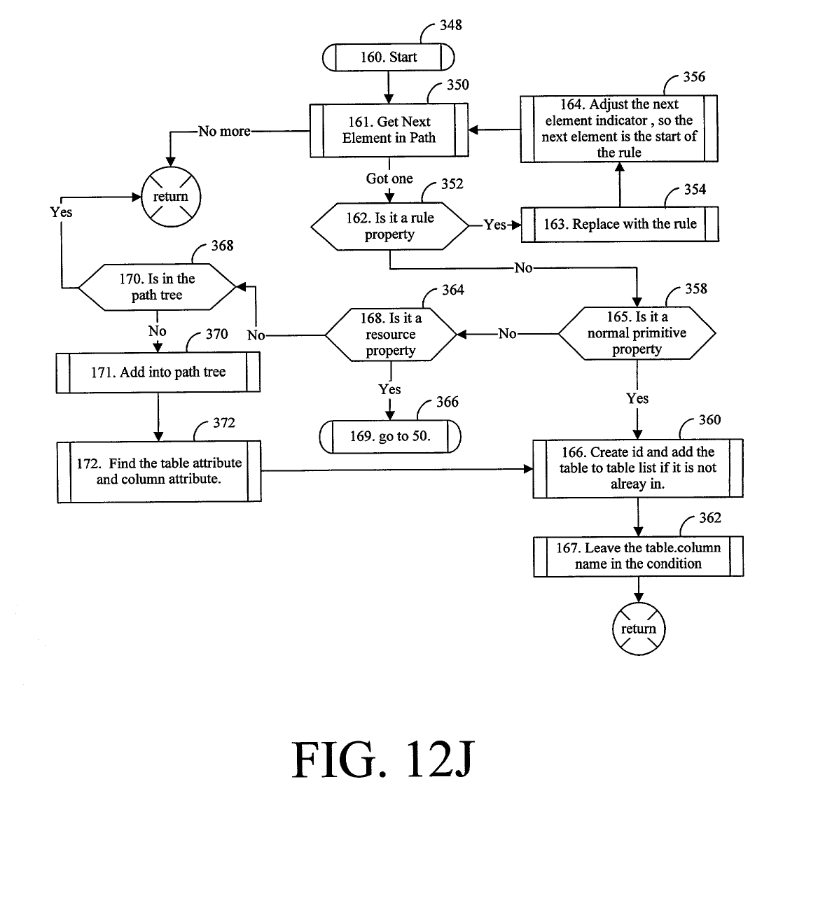

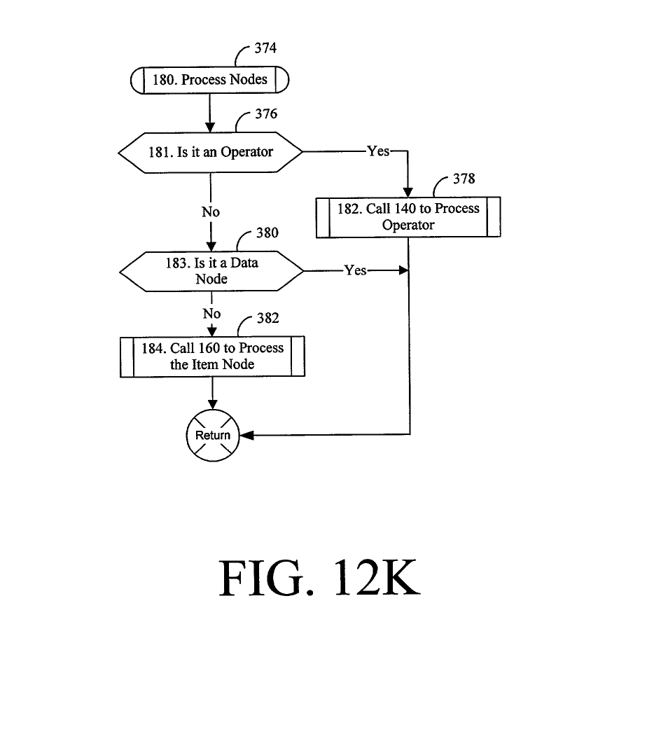

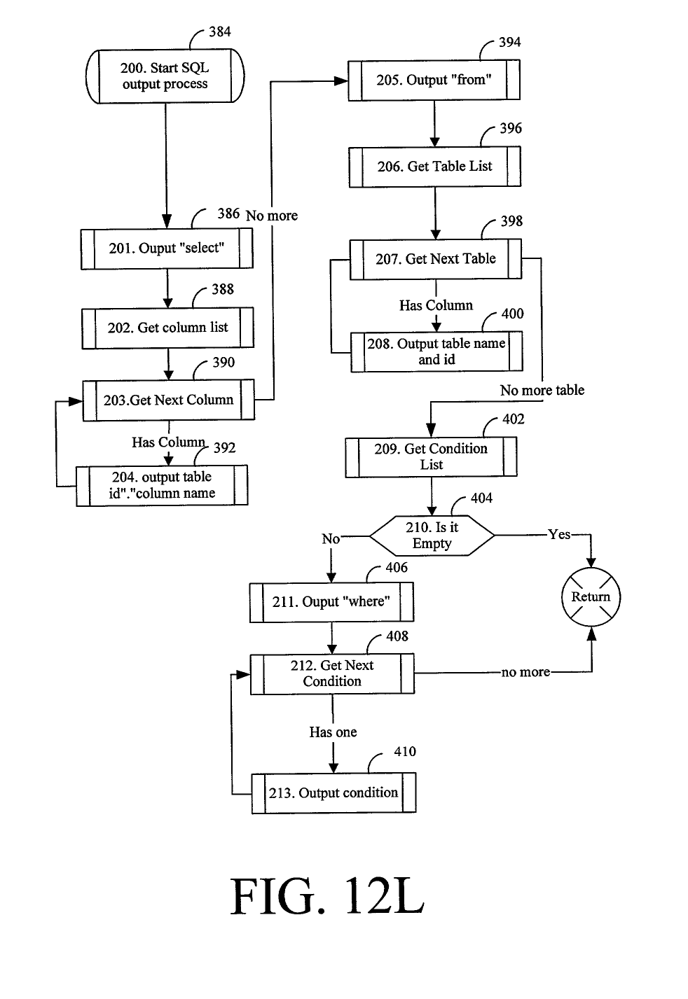

FIG. 12A shows the major steps in the translation process.

Step 1 (194). Get the query to be translated.

Step 2 (196). Use sub-process 10 (200) to process the query. The result is stored in data structures. For example, the table list entries are (music, music1), (artist, artist1), (performer, performer1), (artist, artist2). The first one in each pair is the table and the second one in the pair is its ID. The column list entries are (music1, m_name), (artist1, a_name), artist2, a_name). The first in each pair is table ID and the second one is the column name. The condition list entries are OR(EQUAL(music1.m_name, ‘Yesterday’), EQUAL(music1.m_name, ‘Today’)), EQUAL(music1.m_id, performer1.m_id), EQUAL(artist1.a_id, performer1.a_id), EQUAL(music1.band, artist2.a_id).

Step 3 (198). Use Process 200 (???) to generate the SQL statement from the data structure. The final output, in the example, is

| | |
|---|---|
| SELECT | music1.m_name, artist1.a_name, artist2.a_name |
| FROM | music1, artist1, performer1, artist2 |
| WHERE | ((music1.m_name = ‘Yesterday’) or |
| | (music1.m_name = ‘Today’)) and |
| | (music1.m_id = performer1.mid) and |
| | (artist1.a_id = performer1.aid) and |
| | (music1.band = artist2.aid). |

FIG. 12B shows sub-process 10 (200) of FIG. 12A.

Step 11 (202). At any time, there is a branch consisting of many elements separated by a ‘/’. At the beginning, the whole query can be treated as a branch. For example, music[name=‘Yesterday’ or name=‘Today’] is an element of the branch. The whole branch list {name, composer/name, band/name } is another element of the top level branch. If none of the elements within a branch is a branchlist, it is a path., For example band/name is a path. The first ‘/’ before music implies an empty element which is called the root element. This step gets the next element in the branch. If there are no more elements, the process returns to its caller.

Step 12 (204). A check is made to determine whether or not the element is a branch list such as {name, composer/name, band/name}. If it is a list, go to step 13 (206). Otherwise, go to step 15 (210).

Step 13 (206). Get the next branch in the branch list. In the above example, a branch is name, composer/name or band/name. If there are no more branches, go back to step 11 (202).

Step 14 (208). Process the branch with Process 10 (200), then go back to step 13 (206). In the above case, the branch is name the first time, composer/name the second time, and band/name the third time.

Step 15 (210). Process this element with sub-process 20 (212).

FIG. 12C illustrates the steps in sub-process 20 (212).

Step 21 (214). If the element is a root element, go to step 23 (218). Otherwise, go to step 22 (216).

Step 22 (216). From configuration file, determine if the element maps to a table. If it does, go to step 26 (226), otherwise, it must be a property, so proceed to sub-process 30 (230) to process the property. In the example, the Music resource maps to music table.

Step 23 (218). Add the root element into the path tree.

Step 24 (220). Does the element have any predicate associated with it? If it does, go to step 25 (222). If it does not, return to the caller. For example, Music has the predicate [name=‘Yesterday’ or name=‘Today’]. When processing composer after it is replaced by artist:c[role=‘composer’], artist:c has the predicate [role=‘composer’].

Step 25 (222). Use sub-process 90 (???) to process predicate.

Step 26 (224). If the element is already in the path tree, go to step 24 (220), else go to step 27 (226).

Step 27 (226). If the element is not in the path tree, then add the element into the path tree. For example, after Music is added, the path tree looks like root(Music).

Step 28 (228). Create an identifier for the table and go to step 24 (220). For example, after processing Music, the table list will have (music, music1).

FIG. 12D illustrates the steps of sub-process 30 (230) for processing a property.

Step 31 (232). Check the property's mapping from the configuration file to see whether it is a rule property. If the property is a rule property, go to step 32 (238). Otherwise, go to step 34 (234).

Step 32 (234). Replace the rule property with the rule. The rule must then be processed. In the example, composer is a rule property and is replaced by artist:c[role=‘composer’].

Step 33 (236). Reset the element indicator so that the next element is the start of the rule, and return to caller. For example, in the case of composer, this step will return back to step 11 (202) of sub-process 10 (200). When step 11 (202) gets the next element, it will get artist:c.

Step 34 (238). For a non-rule property, either the property is a normal primitive property that contains numbers, date, text, etc, or a property whose value is a resource. If it is a primitive property, go to Step 35 (240). Otherwise go to Step 37 (224).

Step 35 (240). For a primitive property, find its column attribute in the mapping in the configuration file. The column must belong to a table. Add this column into the column list. Further, add the property into the path tree if it is not there. In the example, the name property of the Music resource has a column attribute with value m_name. Therefore, the name property is mapped to (music1, m_name) and the path tree is root(Music(name)). The music1 is the table ID associated with Music in the path tree.

Step 36 (242). The table of the column is added into the table list if it is not already present and then return to the caller.

Steps 37 (244), 38 (246) and 39 (248). If the property is a resource property, go to subprocess 50 (250). Otherwise go to sub-process 70 (280).

FIG. 12E illustrates the steps in sub-process 50 (250) for processing a resource property.

Steps 51 (252) and 52 (254). Let X be the ID of the table that maps to the resource to which this property belongs. If the resource property is not in the path tree, add it to the path tree. For example, artist:c is a resource property, so it is added into the path tree and the result is root(Music(name), artist:c). Also, band is a resource property. It is added into the path tree root(Music(name, artist:c(name, role), band).

Step 53 (256). Determine from the configuration file whether or not there are a column and a resource attributes in the mapping of this resource property. If there are, go to Step 54 (258), otherwise go to Step 57 (264). For example, band has column=‘band’ and resource=‘Artist’, so it goes to Step 54 (258). On the other hand, the artist property for the artist:c has resource=‘Artist’ and table=‘performer’, but no column attribute, so it goes to Step 57 (264).

Steps 54 (258), 55 (260) and 56 (262). Let the name of the column be ‘fk’. In the example, the band is the name of the column that corresponds to the property band. The column must contain the foreign key for the table that maps to the resource attribute. Find that table's name from the configuration file. Create the table ID of that table and add it to the table list if it is not already present. Let Y be the ID of this table and ‘pk’ be the column name of its primary key. Create a condition “X.fk=Y.pk” and add it into the condition list. Go to Step 63 (276). In the example, the table that corresponds to the Artist resource is artist. Create an ID, artist2. Add (artist, artist2) into the table list. The table artist2 has a_id as its primary key. Create a condition music1.band=artist2.a_id and enter the new condition into the condition list.

Step 57 (264), 58 (266) and 59 (268). If the table in the table attribute is not in the table list, create the table ID and add it to the table list. Let us call this table T. Find the foreign key column in T for X, let it be ‘fkx’. Let the primary key column of X be ‘pkx’. Enter the condition T.fkx=X.pkx into the condition list.

In the example, artist:c has attribute table=‘performer’. The T table is the performer table. Create an ID performer1 for it. Add (performer, performer1) into the table list. Table X is music with ID music1. Table X has primary key m_id. The performer table's foreign key for music is also called m_id. Add the condition “performer1.m_id=music1.m_id” into the condition list.

Step 60 (270), 61 (272) and 62 (274). Find the table that corresponds to the value of the resource attribute. If it is not in the table list, create an ID and add it to the table list. Let it be Y. Find the foreign key in table T for Y, let it be ‘fky’. Let the primary key of Y be ‘pmy’. Add the condition T.fky=Y.pky into the condition list. Following the example, the resource attribute of artist:c is Artist with corresponding table artist. Create an ID, artist1, for it and add (artist, artist1) into the table list. Add the condition performer1.a_id=artist1.a_id into the condition list. Go to Step 63 (276).

Step 63 (276). If there are predicates associated with this property, go to Step 64 (278) to process the predicate, otherwise return.

Step 64 (278). Call sub-process 90 (292) to process the predicate.

FIG. 12F illustrates the steps of the sub-process 70 (280) for processing a path property.

Step 70 (280). A path property is a property depending on the path. In the mapping, a path property is always nested within another property. For example, role in artist:c is a path property in the music mapping.

Step 71 (282). If the property is already in the path tree, terminate this process immediately.

Step 72 (284). If the property is not in the path tree, add it into path tree. For example, before adding role, the path tree may look like root(Music(name, artist(name)). After adding role, the path tree may look like root(Music(name, artist:c(name, role)). Since role is in the predicate, it is not added at this stage.

Step 73 (286) and 74 (288). A path property must have a column attribute and a table attribute in the configuration file's mapping. If the table is not already in the table list, create an ID and add it to the table list. In the example, if performer is not in the table list yet, create one and add it in. Since it is already in the table, there is no need to add it in the example.

Step 75 (290). Add the column into the column list. For example, if role is not within the predicate, it will be added here as (performer1.role). Since it is within a predicate in the example, it will be processed in Process 90 (292). Return to the caller.

FIG. 12G illustrates the steps of the sub-process 90 (292) for processing a predicate.

Step 90 (292). Start processing predicate.

Step 91 (294). Get the predicate expression.

Step 92 (296). Call Process 130 (300) to break down the expression into a tree of smaller units. For example a condition “name=‘Yesterday’ or name=‘Today’” will become OR(EQUAL(name, ‘Yesterday’), EQUAL(name, ‘Today’)).

Step 93 (298). Call Process 140 (316) to process the condition tree and add the condition into the condition list, then return.

FIG. 12H illustrates the steps of sub-process 130 (300) for breaking down an expression.

Step 130 (300). The process of parsing a condition and breaking down them into tree structure is well-known. This process breaks down the expression of conditions into a tree of smaller expressions separated by with operators as its branch nodes and elements as its leaf nodes.

Step 131 (302). Scan the expression and break down conditions into a list of conditions separated by logical operators. Treat the expression within a pair of parentheses as a single unit. The data structure of the list can be and(or(a=3, b=4), c=5).

Step 132 (304). If there is any pair of parentheses around a unit such as (a=3 OR b=5), call sub-process 130 (300), in step 137 (314), to break it down further.

Step 133 (306). For each unit, break it down into smaller unit separated by relational operation such as greater than “>”, less than “<”, equal to “=”, not equal to “!=”, less than or equal to “<=”, greater than or equal to “=>”.

Step 134 (308). If there is any pair of parentheses around a unit, call process 130 (300) to break it down.

Step 135 (310). For each unit, break it down into smaller unit separated by arithmetic operators such as plus “+”, minus “−”, multiply “*”, divide “/”, mod, quo, rem and subselect operator such as all and exist.

Step 136 (312). If there is any pair of parentheses around a unit, call sub-process 130 (300), in step 137 (314), to break it down. Then return.

Step 137 (314). Call (recursively) sub-process 130 (300).

FIG. 12I illustrates the steps of sub-process 140 (316) for processing a condition tree.

Step 140 (316). The input is a tree structure of nodes with operator as branch nodes. For binary operator, it has both a left hand side and a right hand side. For unary operator, it only has a right hand side. Get the root node of the tree, which must be an operator.

Step 141 (318). If the operator is a subselect operator such as “all”, “exist”, go to Step 149 (334).

Step 142 (320) and 143 (322). If the operator is a binary operator, call Process 180 (374) to process the left hand side subtree. Save the result as “left hand”.

Step 144 (324). Call Process 180 (374) to process the right hand side subtree. Save the result as “right hand”.

Step 145 (326), 146 (328), and 147 (330). If the operator is a binary operator, set the condition to be operator(“left hand”,“right hand”) else operator(“right hand”). For example=(a,‘2’) and !(a) are conditions.

Step 148 (332). Add the condition into the condition list and return.

Step 149 (334). Save current table list, condition list, and column list. Create a new empty one for each of them.

Step 150 (336). Call sub-process 180 (374) to process Right hand side. Save the result to be “right hand”.

Step 151 (338) and 152 (340). Create condition to be operator(“right hand”) and add it into the condition list.

Step 153 (342). Set a buffer and call sub-process 200 (384) to output the subselect query into the buffer.

Step 154 (344). Restore table list, column list and condition list.

Step 155 (346). Add the buffer content into condition list, then return.

FIG. 12J illustrates the steps for sub-process 160 (348) for processing a path inside of a predicate.

Step 160 (348). This step processes a path inside a predicate. A path is similar to a branch except it does not allow branch list as its element. To illustrate this operation, the example is slightly altered. /Music[band/age>‘5’ and (singer/name=‘Madonna’ or name=‘Yesterday’)]/name. The predicate [band/age>5 and (singer/name=‘Madonna’ or name=‘Yesterday’] has paths band/age, singer/name and name of the music.

Step 161 (350). Get next element in path. Exit this operation if no more element left in the path. For band/age, the first time is band and the second time is age. The operation continue to the next step if a next element is found in the path.

Steps 162 (352), 163 (354), and 164 (356). If the property is not a rule property, continue the operation to Step 165 (358). Otherwise, replace it by the rule and reprocess with the start of the rule as the start of the next element. For example, if the path is singer/name and the element is singer. It is replaced by artist:s[role=‘singer’]. The next element in this path will be artist:s.

Step 165 (358). Determine whether the property is a normal primitive property if it is not a rule property. If it is a normal primitive property, find the column then go to Step 166 (360). Otherwise go to Step 168 (364).

Steps 166 (360) and 167 (362). If the table does not exist, then create an ID for it and add the table into the table list. Leave the table.column in place of the path. This table.column will be used by the caller to construct the condition tree. Return to the caller once complete the operation. For example, band/age will become artist1.age. artist:s[role=‘singer’]/name will become artist2.name. name will become music1.name.

Steps 168 (364) and 169 (365). If the property is not a primitive resource, then check if it is a resource property. If it is, then go to Step 50 (250). Otherwise the operation continue to Step 170 (368).

Step 170 (368). If the property is neither a primitive property nor a resource property, then it must be a path property. However, if the property is not in the path tree, add it in as one. Get the table attribute and the column attribute of this property and proceed to Step 166 (360). For example, the role property has column attribute role and table attribute performer.

FIG. 12K illustrates the steps of sub-process 180 (374) for processing nodes.

Step 180 (374). Process nodes, which are the root node of a subtree or a leaf node. For example, a tree of nodes may in the form of AND(GREATER(band/age, '5), OR(EQUAL(name, ‘Yesterday’), EQUAL(singer/name, ‘Madonna’)))

Steps 181 (376) and 182 (378). If the node is an operator, call Process 140 (316) to process this subtree, then return. Otherwise, go to Step 183 (380). For example, AND, OR, GREATER and EQUAL are operator nodes.

Step 183 (380). Determine whether the node is a data node if it is not an operator. Data node is a number or a string of characters. After determining whether the node is a data node, the operation returns to the caller. For example, '5, ‘Yesterday’ and ‘Madonna’ are data nodes.

Step 184 (382). The node is a path if it is neither an operator nor a data node. Call process 160 (348) to process the node, then return. For example, band/age and name are both paths.

FIG. 12L illustrates the steps of sub-process 200 (384), which forms the SQL statement.

Step 200 (384). This operation is for forming an SQL statement. For example, the table list has entries (music, music1), (artist, artist1), (performer, performer1), (artist, artist2). The first one in each pair is the table and the second one in the pair is its ID. The column list has entries, (music1, m_name), (artist1, a_name), (artist2, a_name). The first in each pair is table ID and the second one is the column name. The condition list has entries, OR(EQUAL(music1.mname, ‘Yesterday’), EQUAL(music1.mname, ‘Today’)), EQUAL(music1.mid, performer1.mid), EQUAL(artist1.aid, performer1.aid), EQUAL(music1.band, artist2.aid).

Step 201 (386). Output the “SELECT” first.

Step 202 (388). Get the column list.

Steps 203 (390) and 204 (392). Get the next column in the list. If there are no more columns, go to Step 205 (394). Otherwise, output the table id.column name, then repeat the Step 203 390). For table x column a, the output should be x.a. For example, the output will be music1.m_name, artist1.a_name, artist2.a_name.

Step 205 (394). Output “FROM”.

Step 206 (396). Get the table list.

Steps 207 (398) and 208 (400). Get the next table in the list. If there are no more tables, go to Step 209 (402). Otherwise, output table name and ID. Then, repeat Step 207 (398). For example, table with the name in the database called MUSIC and its ID is x, the output should be MUSIC x. For example, the output will be music1, artist1, performer1, artist2.

Steps 209 (402) and 210 (404). Get the condition list. Return to the caller if nothing in the condition list. Otherwise go to Step 211 (406).

Step 211(406). Output “WHERE”.

Steps 212 (408) and 213 (410). Get next condition. If no more conditions, return to the caller. Otherwise, output the condition, then repeat Step 212 (408). The output are in the forms of ((music1.m name=‘Yesterday’) or (music1.m_name=‘Today’)) and (music1.m_id=performer1.m_id) and (artist1.a_id=performer1.a_id) and (music1.band=artist2.a_id).

Although the present invention has been described in considerable detail with reference to certain preferred versions thereof, other versions are possible. Therefore, the spirit and scope of the appended claims should not be limited to the description of the preferred versions contained herein.

What is claimed is:

1. A method of translating a query based on a resource-property model into a statement for querying a relational database, comprising:
for each rule property in or derived from the resource-property query,
substituting the rule string for the rule property;
for each resource and resource property in or derived from the query,
assigning a relational table having an id to the resource or resource property and entering the assigned table id into a table list;
for each resource property in or derived from the query,
determining any implied conditions based on the resource property and entering the implied conditions into a condition list;
for each primitive property in or derived from the query,
assigning a table and column to the primitive property and entering the table and column into a column list;
for each predicate in or derived from the query,
resolving the predicate into one or more conditions and entering the one or more conditions into the condition list; and
forming an a relational query statement from the column list, the table list and the condition list.

2. A system for translating a query language, comprising:
a query translator;
a first input coupled to said translator for receiving a universal query language statement;
a second input coupled to said translator for receiving a configuration information; and
an output coupled to said translator for generating a structured query language statement.

3. A system for translating a query language as recited in claim 2, wherein said configuration information provides a property mapping information between resources in the universal query language statement and the structured query language statement.

4. A system for translating a query language as recited in claim 3, wherein said translator includes a table for translating to said structured query language.

5. A system for translating a query language as recited in claim 2, wherein said configuration information further comprising:
a first entity including an identification field and an identity field of a said first entity;
a second entity including an identification field and an identity field of said second entity; and
a third entity having a first field for identifying an entry in said first entity to link the first entity and said third entity together.

6. A system for translating a query language as recited in claim 5, wherein said third entity further including a second field for identifying an entry in said second entity.

7. A system for translating a query language as recited in claim 6, wherein said third entity having a field for identifying the position of said entity identified in the second field.

8. A system for translating a query language as recited in claim 5, wherein said first field of said third entity is equivalent to a content in the identification field of said first entity.

9. A system for translating a query language as recited in claim 5, wherein said first field of said third entity is equivalent to a content in the identification field of said second entity.

10. A system for translating a query language as recited in claim 5, wherein said first field of said third entity is a key to the first entity connecting said third entity to said first entity.

11. A system for translating a query language as recited in claim 5, wherein said first field of said third entity is a key to the second entity connecting said third entity to said second entity.

12. A system for translating a query language as recited in claim 5, wherein said first entity further comprising a key linking said first entity to said second entity.

13. A system for translating a query language as recited in claim 12, wherein said second entity further including a key linking said second entity to said third entity.

14. A system for translating a query language as recited in claim 13, wherein said first entity is indirectly linked to said third entity via said second entity.

15. A method of translating a query based on a resource-property modelstring into a statement for querying a relational database, wherein the resource-property having at least one rule and said query having at least one rule string, comprising:
providing at least one resource in said model;
providing at least one property in each resource;
substituting the rule string for a rule property in the resource-property query;
assigning a relational table having an ID to the resource and entering the assigned table ID into a table list for each resource and resource property in the query;
determining any link element based on the resource property and entering the link element into a link list for each resource property in the query;
assigning a table and column to a primitive property and entering the table and column into a column list for each primitive property in the query; and
forming a relational query statement from the column list, the table list and the link list.

16. A method of translating a query as recited in claim 15, after assigning the table and column further comprising:
resolving a predicate into a condition and entering the condition into a condition list for each predicate in the query.

17. A method of translating a query based on a resource-property modelstring into a statement for querying a relational database, wherein the resource-property having at least one rule and said query having at least one rule string, comprising:
providing at least one resource in said model;
providing at least one property in each resource;
substituting the rule string for a rule property derived from the resource-property query;
assigning a relational table having an ID to the resource and entering the assigned table ID into a table list for each resource and resource property derived from the query;
determining any link element based on the resource property and entering the link element into a link list for each resource property derived from the query;
assigning a table and column to a primitive property and entering the table and column into a column list for each primitive property derived the query; and
forming a relational query statement from the column list, the table list and the link list.

18. A method of translating a query as recited in claim 17, after assigning the table and column further comprising:
resolving a predicate into a condition and entering the condition into a condition list for each predicate in the query.

19. A computer program product embodying a program of instructions executable by a machine to perform method steps for translating a query based on a resource-property model having a rule string into a statement for querying a relational database, wherein the resource-property having at least one rule and said query having at least one rule string, comprising:
substituting the rule string for the rule property for each rule property in or derived from the resource-property query;
assigning a relational table having an ID to the resource or resource property and entering the assigned table id into a table list for each resource and resource property in or derived from the query;
determining any implied conditions based on the resource property and entering the implied conditions into a condition list for each resource property in or derived from the query;
assigning a table and column to the primitive property and entering the table and column into a column list for each primitive property in or derived from the query;
resolving the predicate into one or more conditions and entering the one or more conditions into the condition list for each predicate in or derived from the query; and forming an a relational query statement from the column list, the table list and the condition list.
